(19) United States
(12) Patent Application Publication
(10) Pub. No.: US 2015/0237641 A1
(43) Pub. Date: Aug. 20, 2015

(54) METHODS AND APPARATUS FOR PRIORITIZING IMS CLIENTS OVER SOFTAP

(71) Applicant: QUALCOMM Incorporated, San Diego, CA (US)

(72) Inventors: Debesh Kumar Sahu, Hyderabad (IN); Vishvadeep Gopalbhai Devnani, Hyderabad (IN); Bala Krishna Kotha, Hyderabad (IN); Naresh Gundu, Hyderabad (IN); Srinivasan Balasubramanian, San Diego, CA (US); Subbarayudu Mutya, Hyderabad (IN)

(73) Assignee: QUALCOMM Incorporated, San Diego, CA (US)

(21) Appl. No.: 14/185,762

(22) Filed: Feb. 20, 2014

(51) Int. Cl. H04W 72/10; H04W 76/06; H04L 29/06; H04B 7/14

(52) U.S. Cl. CPC H04W 72/10; H04B 7/14; H04W 76/066; H04L 65/1096

(57) ABSTRACT

A method for wireless communication by a wireless relay device comprises receiving, over a first wireless connection of a first connection type between a first wireless device and the relay device, a request to establish a connection between the first wireless device and a network via the first wireless connection and a second wireless connection of a second connection type between the relay device and the network. The method further comprises determining a priority associated with the first wireless device based on at least one parameter associated with the first wireless device. The method further comprises establishing, at the relay device, the connection between the first wireless device and the network when the priority associated with the first wireless device is higher than a priority associated with at least one of a plurality of other wireless devices having a connection with the network via the second wireless connection.

### BACKGROUND

1. Field

The present application relates generally to wireless communications, and more specifically to methods and apparatus for prioritizing IP multimedia subsystem (IMS) clients over a software access point (softAP).

2. Background

Wireless communication systems are widely deployed to provide various types of communication content such as voice, video and/or data. However, wireless devices not compatible with a particular service, for example voice over LTE (VoLTE), but equipped with WiFi, for example, may place IMS calls through another VoLTE-capable wireless device via a WiFi connection with the VoLTE-compatible wireless device by tethering to the VoLTE-compatible device. In such a configuration, the VoLTE-compatible wireless device may also be called a SoftAP. However, there are cases where the number of IMS calls allowed through a SoftAP will be limited. For example, some operators may limit the number of VoLTE calls through a particular SoftAP to some number, for example 4, to manage and meet quality of service (QoS) requirements. Similarly, there may be limits for other services like video telephony or rich communication services (RCS), for example. Consequently, when a new IMS client attempts to bring up an IMS call, it may be denied service if the maximum number of calls or connections are already active through the SoftAP. Accordingly, there is a need for a mechanism to prioritize IMS clients in VoWLAN configurations.

### SUMMARY

Various implementations of methods and apparatus within the scope of the appended claims each have several aspects, no single one of which is solely responsible for the desirable attributes described herein. Without limiting the scope of the appended claims, some prominent features are described herein. Other features, aspects, and advantages will become apparent from the description, the drawings, and the claims.

In one implementation, a method for wireless communication by a wireless relay device is provided. The method includes receiving, over a first wireless connection of a first connection type between a first wireless device and the relay device, a request to establish a connection between the first wireless device and a network via the first wireless connection and a second wireless connection of a second connection type between the relay device and the network. The method includes determining a priority associated with the first wireless device based on at least one parameter associated with the first wireless device. The method includes establishing, at the relay device, the connection between the first wireless device and the network when the priority associated with the first wireless device is higher than a priority associated with at least one of a plurality of other wireless devices having a connection with the network via the second wireless connection.

In another implementation, an apparatus for wireless communication is provided. The apparatus includes a receiver configured to receive, over a first wireless connection of a first connection type between a first wireless device and the apparatus, a request to establish a connection between the first wireless device and a network via the first wireless connection and a second wireless connection of a second connection type between the apparatus and the network. The apparatus includes a processor. The processor is configured to determine a priority associated with the first wireless device based on at least one parameter associated with the first wireless device. The processor is further configured to establish, at the apparatus, the connection between the first wireless device and the network when the priority associated with the first wireless device is higher than a priority associated with at least one of a plurality of other wireless devices having a connection with the network via the second wireless connection.

In another implementation, a non-transitory computer-readable medium comprising code is provided. The code, when executed, causes an apparatus to receive, over a first wireless connection of a first connection type between a first wireless device and the relay device, a request to establish a connection between the first wireless device and a network via the first wireless connection and a second wireless connection of a second connection type between the relay device and the network. The code, when executed, causes the apparatus to determine a priority associated with the first wireless device based on at least one parameter associated with the first wireless device. The code, when executed, causes the apparatus to establish, at the apparatus, the connection between the first wireless device and the network when the priority associated with the first wireless device is higher than a priority associated with at least one of a plurality of other wireless devices having a connection with the network via the second wireless connection.

In another implementation, an apparatus for wireless communication is provided. The apparatus comprises means for receiving, over a first wireless connection of a first connection type between a first wireless device and the apparatus, a request to establish a connection between the first wireless device and a network via the first wireless connection and a second wireless connection of a second connection type between the apparatus and the network. The apparatus comprises means for determining a priority associated with the first wireless device based on at least one parameter associated with the first wireless device. The apparatus comprises means for establishing, at the apparatus, the connection between the first wireless device and the network when the priority associated with the first wireless device is higher than a priority associated with at least one of a plurality of other wireless devices having a connection with the network via the second wireless connection.

### BRIEF DESCRIPTION OF THE DRAWINGS

FIG. 1 illustrates an example of a wireless communication network in which aspects of the present disclosure may be employed.

FIG. 2 illustrates another example of a wireless communication network in which aspects of the present disclosure may be employed.

FIG. 3 illustrates an example of a functional block diagram of a wireless device that may be employed within the wireless communication network of FIG. 1 and/or FIG. 2.

FIG. 4 illustrates a signal exchange diagram for providing IMS clients with VoWLAN capability via a softAP without IMS client prioritization.

FIG. 5 illustrates a signal exchange diagram for prioritizing IMS clients over a SoftAP, as may be employed within the wireless communication network of FIG. 1 and/or FIG. 2.

FIG. 6 illustrates a flowchart of an exemplary method for wireless communication by a wireless relay device that may be employed within the wireless communication network of FIG. 1 and/or FIG. 2.

FIG. 7 illustrates an example of a functional block diagram of an apparatus for wireless communication that may be employed within the wireless communication network of FIG. 1 and/or FIG. 2.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the invention. Details are set forth in the following description for purpose of explanation. It should be appreciated that one of ordinary skill in the art would realize that the invention may be practiced without the use of these specific details. In other instances, well known structures and processes are not elaborated in order not to obscure the description of the invention with unnecessary details. Thus, the present invention is not intended to be limited by the implementations shown, but is to be accorded with the widest scope consistent with the principles and features disclosed herein.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

It should be emphasized that the disclosed techniques may also be applicable to technologies and the associated standards related to LTE Advanced, LIE, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth. Terminologies associated with different technologies can vary. For example, depending on the technology considered, the User Equipment (UE) used in UMTS can sometimes be called a mobile station, a user terminal, a subscriber unit, an access terminal, etc., to name just a few. Likewise, Node B used in UMTS can sometimes be called an evolved Node B (eNodeB), an access node, an access point, a base station (BS), HRPD base station (BTS), and so forth. It should be noted here that different terminologies apply to different technologies when applicable.

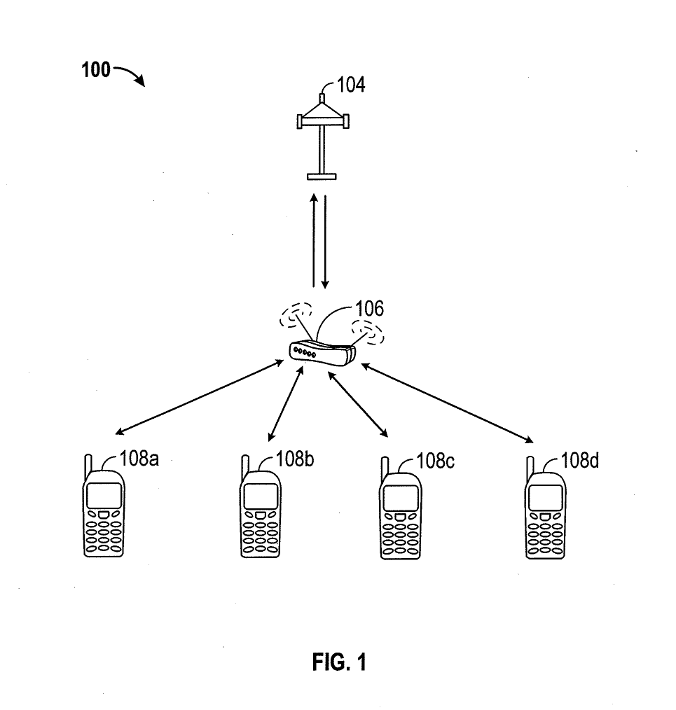

FIG. 1 illustrates an example of a wireless communication network 100 in which aspects of the present disclosure may be employed. The wireless communication system 100 may include an access point (AP) 104, a software access point (SoftAP) 106 and a plurality of wireless devices 108a, 108b, 108c and 108d, hereinafter collectively wireless devices, STAs or IMS clients 108a-108d. The AP 104 may provide direct access to a fourth generation (4G) long term evolution (LTE) wireless network, for example, for 4G LTE-capable wireless devices within a basic service area for the AP 104. The SoftAP 106 may also be referred to as a wireless relay device or modem and may comprise a wireless device or apparatus having 4G LTE capability and also having a wireless relay or hotspot capability such that one or more wireless devices not having or not currently utilizing 4G LTE capability, for example IMS clients 108a-108d, may utilize the SoftAP 106 as a wireless relay device or hotspot for providing a connection between the non-4G-LTE-capable IMS clients 108a-108d and the 4G LIE network at AP 104. Such a connection may comprise or provide for at least one of a default bearer with QCI-5 for IMS signaling, a dedicated bearer with QCI-1 for voice communications, and a dedicated bearer with QCI-2 for video communications as may be understood by those of ordinary skill in the art. In some implementations, the IMS clients 108a-108d may be 2G and/or 3G capable devices. The SoftAP 106 may further provide prioritizing of the IMS clients' 108a-108d connections to the 4G LTE network, through the SoftAP 106, based on at least one characteristic associated with one or more of the IMS clients 108a-108d, as will be described in more detail below. For purposes of completeness, the IMS clients 108a-108d, may alternatively be 4G-LTE-capabable but may not utilize such capability and instead may communicate with the 4G LTE network via another type of connection, such as WiFi, through the SoftAP 106.

For the purposes of this application, an access point (AP) may comprise, be implemented as, or known as a Node B, Radio Network Controller (RNC), eNodeB, Base Station Controller (BSC), Base Transceiver Station (BTS), Base Station (BS), Transceiver Function (TF), Radio Router, Radio Transceiver, or some other terminology.

For the purposes of this application, a station (STA) may comprise, be implemented as, or known as an access terminal (AT), a subscriber station, a subscriber unit, a mobile station, a remote station, a remote terminal, a user terminal, a user agent, a user device, user equipment (UE), an IMS client or some other terminology. In some implementations an access terminal may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects disclosed herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a wireless sensor device, a global positioning system device, or any other suitable device that is configured to communicate via a wireless medium.

A variety of processes and methods may be used for transmissions in the wireless communication system 100 between the AP 104 and the IMS clients 108a-108d via the SoftAP 106. A communication link that facilitates transmission from the AP 104 to the SoftAP 106 or from the SoftAP 106 to any of the IMS clients 108a-108d may be referred to as a downlink (DL), and a communication link that facilitates transmission from any of the IMS clients 108a-108d to the SoftAP 106 or from the SoftAP 106 to the AP 104 may be referred to as an uplink (UL). Alternatively, a downlink may be referred to as a forward link or a forward channel, and an uplink may be referred to as a reverse link or a reverse channel.

The AP 104 may be configured as a base station and provide wireless communication coverage in a basic service area (BSA) associated with the AP 104. Depending on the technology considered, a basic service area can sometimes be called a coverage area, cell, etc. The AP 104 along with the SoftAP 106 and the IMS clients 108a-108d may be referred to as a basic service set (BSS).

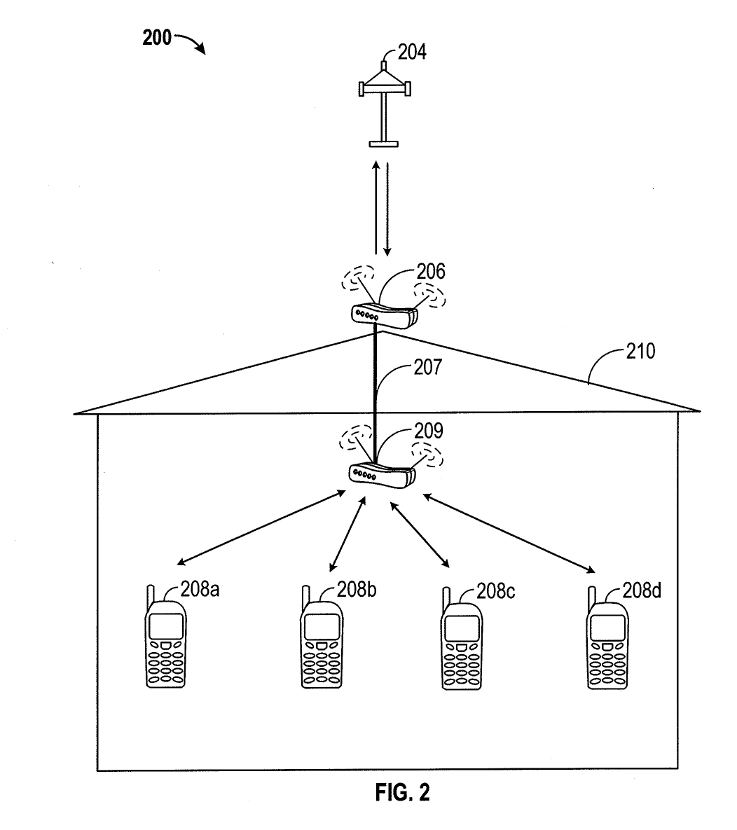

FIG. 2 illustrates another example of a wireless communication network 200 in which aspects of the present disclosure may be employed. The wireless communication system 200 may be substantially the same as the wireless communication system 100 shown in FIG. 1 with the exception that the SoftAP 206 may comprise an outdoor router and may be connected to a home gateway 209 via a physical connection 207, such as an Ethernet connection. The wireless communication network 200 may comprise an access point (AP) 204, a software access point (SoftAP) 206 connected to the home gateway 209 via the physical connection 207, and a plurality of IMS clients 208a, 208b, 208c and 208d, hereinafter collectively the IMS clients 208a-208d. The operation of each of the AP 204, the SoftAP 206 and IMS clients 208a-208d may be substantially as described above in connection with the AP 104, the SoftAP 106 and the IMS clients 108a-108d of FIG. 1, respectively. The SoftAP 206 may operate in conjunction with the home gateway 209 as the wireless relay device or hotspot for providing the connection between the non-4G-LTE-capable IMS clients 208a-208d and the 4G LTE network at the AP 204. The home gateway 209 may be WiFi-compatible and may provide a WiFi connection with one or more of the IMS clients 208a-208d. In addition, in some implementations, power line communication (PLC) may be utilized to extend WiFi connectivity to all rooms in a building 210. Thus, any device either not currently utilizing, or not configured for, 4G-LIE communication that is located substantially within or near the building 210 may be served by the SoftAP 206 via the home gateway 209 and physical connection 207. Thus, subsequent discussions describing a modem, wireless relay device, or SoftAP may refer to the SoftAP 206 alone or in combination with the home gateway 209.

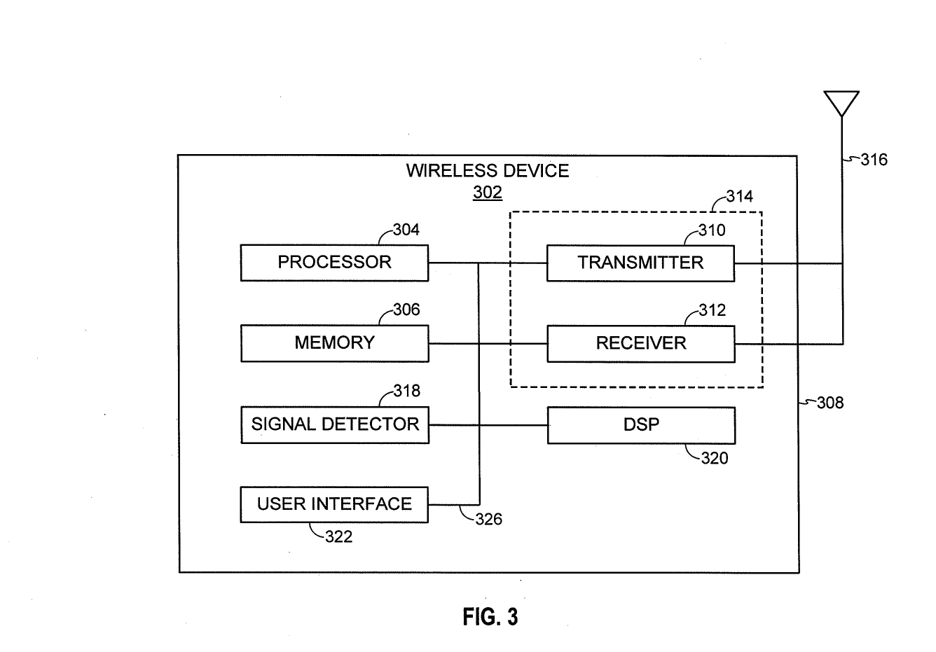

FIG. 3 illustrates an example of a functional block diagram of a wireless device that may be employed within the wireless communication networks of FIG. 1 and/or FIG. 2. The wireless device 302 is an example of a device that may be configured to implement the various methods described herein. For example, the wireless device 302 can comprise a SoftAP, such as the SoftAP 106/206. As another example, the wireless device 302 may be a multimode or multiband device capable of operating using different radio access technologies (RATs), such as using WiFi, LTE, LTE Advanced, HSPA, CDMA, HRPD, eHRPD, CDMA2000, GSM, GPRS, EDGE, UMTS, or the like.

The wireless device 302 may include a processor 304 which controls operation of the wireless device 302. The processor 304 may also be referred to as a central processing unit (CPU) or hardware processor. A memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The data in memory 306 may include configuration data. Configuration data may be preloaded into the memory 306. Configuration data may be obtained from a user of the wireless device 302 (e.g., through a user interface 322, SIM card, download, over the air). The processor 304 may perform logical and arithmetic operations further based on the configuration data.

In some aspects, the processor 304 is configured to cause signals to be sent to and to be received from another device (e.g., the AP 104/204, the IMS clients 108a-108d and/or 208a-208d, etc.). The processor 304 may be further configured to enforce access permissions.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory computer-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions or code, when executed by the one or more processors, cause the processing system to perform the various functions described herein.

The wireless device 302 may also include a housing 308 that includes the transmitter 310 and/or the receiver 312 to allow transmission and reception of data between the wireless device 302 and one or more remote locations. The transmitter 310 and receiver 312 may be combined into a transceiver 314. An antenna 316 may be attached to the housing 308 and electrically coupled to the transceiver 314. The wireless device 302 may also include (not shown) multiple transmitters, multiple receivers, multiple transceivers, and/or multiple antennas.

The wireless device 302 may also include a signal detector 318 that may be used in an effort to detect and quantify the level of signals received by the transceiver 314. The signal detector 318 may detect such signals as total energy, energy per subcarrier per symbol, power spectral density, and other signals. The wireless device 302 may also include a digital signal processor (DSP) 320 for use in processing signals. The DSP 320 may be configured to generate a packet for transmission and/or process a received packet.

In some aspects, the wireless device 302 may further comprise a user interface 322. The user interface 322 may comprise a keypad, a microphone, a speaker, and/or a display. The user interface 322 may include any element or component that conveys information to a user of the wireless device 302 and/or receives input from the user.

The various components of the wireless device 302 may be coupled together by a bus system 326. The bus system 326 may include a data bus, for example, as well as a power bus, a control signal bus, and a status signal bus in addition to the data bus. Those of skill in the art will appreciate the components of the wireless device 302 may be coupled together or accept or provide inputs to each other using some other mechanism.

Although a number of separate components are illustrated in FIG. 3, those of skill in the art will recognize that one or more of the components may be combined or commonly implemented. For example, the processor 304 may be used to implement not only the functionality described above with respect to the processor 304, but also to implement the functionality described above with respect to the signal detector 318 and/or the DSP 320. Further, each of the components illustrated in FIG. 3 may be implemented using a plurality of separate elements. For example, the processor 304 and the memory 306 may be embodied on a single chip. The processor 304 may additionally, or in the alternative, contain memory, such as processor registers. Similarly, one or more of the functional blocks or portions of the functionality of various blocks may be embodied on a single chip. Alternatively, the functionality of a particular block may be implemented on two or more chips.

In this specification and the appended claims, it should be clear that the terms “circuit” and “circuitry” are construed as a structural terms and not as functional terms. For example, circuitry can be an aggregate of circuit components, such as a multiplicity of integrated circuit components, in the form of processing and/or memory cells, units, blocks, and the like, such as shown and described in FIG. 3. One or more of the functional blocks and/or one or more combinations of the functional blocks described with respect to the wireless device 302 may also be implemented as a combination of computing devices, e.g., a combination of a DSP and a microprocessor, a plurality of microprocessors, one or more microprocessor in conjunction with a DSP communication, or any other such configuration.

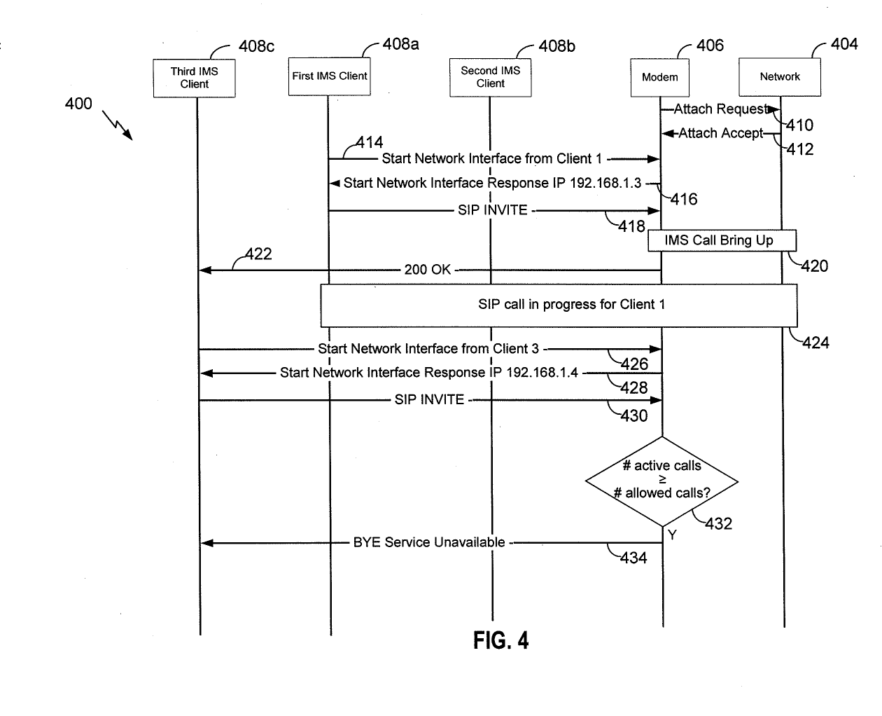

FIG. 4 illustrates a signal exchange diagram for providing IMS clients with VoWLAN capability via a SoftAP without IMS client prioritization. The signal diagram illustrates several components of a communication system. The diagram includes a network 404, a modem 406, a first IMS client 408a, a second IMS client 408b, and a third IMS client 408c. The network 404, the modem 406, the first IMS client 408a, the second IMS client 408b, and the third IMS client 408c may correspond to the AP 104, the SoftAP 106, the IMS client 108a, the IMS client 108b and the IMS client 108c, respectively. Each of the IMS clients 408a-408c may be configured to communicate over a WiFi connection, for example, but may be incapable of communicating over a 4G LTE connection, while the modem 406 may be configured to act as a SoftAP between any of the IMS clients 408a-408c and the network 404. In such a case, the modem 406 may transmit/receive communications to/from one or more of the IMS clients 408a-408c via a WiFi connection and relay those communications from/to the network 404 via a 4G LTE connection, for example. Although the example shown in FIG. 4 includes only three IMS clients, the present application is not so limited and FIG. 4 could alternatively include any number of IMS clients.

Initial signaling may be performed between the modem 406 and the network 404 in order to attach to the 4G LTE network. For example, an attach request message 410 may be transmitted from the modem 406 to the network 404. The network 404 may transmit an attach accept message 412 back to the modem 406 indicating to the modem 406 that the attach request was accepted and that an LTE connection has been established between the modem 406 and the network 404.

In a subsequent step, the first IMS client 408a may transmit a start network interface message 414 indicating a request to establish a connection from the first IMS client 408a to the network 404 via a WiFi connection to the modem 406 and an LTE connection from the modem 406 to the network 404. The modem 406 may transmit a start network interface response message 416, which may indicate an IP address (e.g., 192.168.1.3) that will be associated with the WiFi connection between the first IMS client 408a and the modem 406. In response, the first IMS client 408a may transmit a session initiation protocol (SIP) invite message 418 to the modem 406, after which the modem 406 may perform an IMS call bring up 420 to establish an IMS call session between the IMS client 408a and the network 404 via the modem 406. When the IMS call has been established, the modem 406 may forward an HTTP response 422 having a 200 code indicating that the request for IMS call bring up with the network 404 was successful. From this point forward, the SIP call between the first IMS client 408a and the network 404, via the modem 406, may be in progress as shown by SIP call in progress for the first IMS client block 424. Although not shown, one or more other IMS clients, for example the second IMS client 408b, may additionally set up a connection to the network 404 via a WiFi connection to the modem 406 and an LTE connection from the modem 406 to the network 404.

In this example, subsequent to the first IMS client 408a (and possibly one or more other IMS clients) establishing the connection to the network 404 via the modem 406, the third IMS client 408c may attempt to initiate a similar connection with the network 404. The third IMS client 408c may transmit a start network interface message 426 indicating a request to establish a connection from the third IMS client 408c to the network 404 via a WiFi connection to the modem 406 and an LTE connection from the modem 406 to the network 404. The modem 406 may transmit a start network interface response message 428, which may indicate an IP address (e.g., 192.168.14) that will be associated with the WiFi connection between the third IMS client 408c and the modem 406. In response, the third IMS client 408c may transmit an SIP invite message 430 to the modem 406.

However, in order to ensure QoS for all devices on the network 404, there may be one or more policies in place limiting the number of concurrent connections between IMS clients 408a-408c and the network 404 via a particular SoftAP (e.g., the modem 406). Such limits may apply not only to calls, such as VoLTE but also to video telephony, rich communication service (RCS), etc. Where IMS prioritizing is not supported, the IMS clients 408a-408c may establish connections to the network 404 via the modem 406 on a first-come-first-serve basis. Accordingly, once the number of allowed calls or connections through the modem 406 have been reached, subsequent requests to establish a VoLTE connection, for example, will be denied or rejected without regard to any priority of the requesting IMS client or call type. For example, after receiving the SIP invite message 430, the modem 406 may make a determination 432 as to whether the number of active calls is greater than or equal to the number of allowed calls. If the answer is no, the modem 406 may perform another IMS call bring up for establishing the connection for third IMS client 408c similar to the IMS call bring up 420 for the first IMS client 408a. However, if the answer to determination 432 is yes, as shown in FIG. 4, the modem 406 may transmit a rejection BYE message 434 to the third IMS client 408c indicating that the service is unavailable. Thus, in view of the conventional operation outlined above regarding FIG. 4, there exists a need for a mechanism to prioritize IMS clients in VoWLAN configurations.

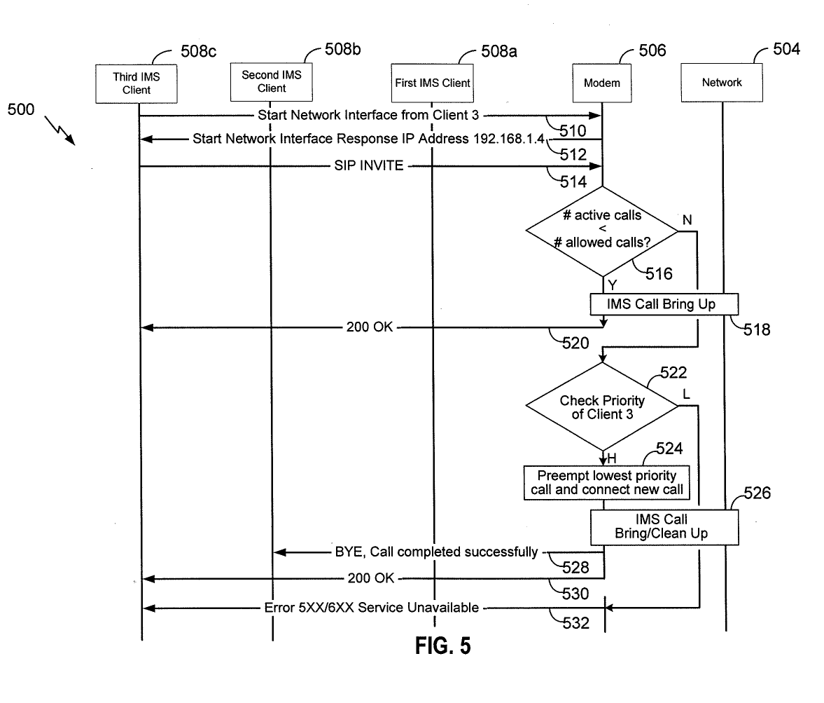

FIG. 5 illustrates a signal exchange diagram for prioritizing IMS clients over a SoftAP, as may be employed within the wireless communication network of FIG. 1 and/or FIG. 2. The signal diagram illustrates several components of a communication system. The diagram includes a network 504, a modem 506, a first IMS client 508a, a second IMS client 508b, and a third IMS client 508c. The network 504, the modem 506, the first IMS client 508a, the second IMS client 508b, and the third IMS client 508c may correspond to the AP 104, the SoftAP 106, the IMS client 108a, the IMS client 108b and the IMS client 108c, respectively. Each of the IMS clients 508a-508c may be configured to communicate over a WiFi connection, for example, but may be incapable of communicating over a 4G LTE connection, while the modem 506 may be configured to act as a SoftAP between any of the IMS clients 508a-508c and the network 504. For example, the IMS clients 508a-508c may be 2G/3G-compatible cellular phones. The modem 506 may be a MiFi router, for example, and may be configured to transmit/receive communications to/from one or more of the IMS clients 508a-508c via a WiFi connection and relay those communications from/to the network 504 via a 4G LTE connection, for example. Although the example shown in FIG. 5 includes only three IMS clients, the present application is not so limited and FIG. 5 could alternatively include any number of IMS clients.

Not shown in FIG. 5 is the initial signaling performed by the modem 506 to attach to the LTE network. However, such signaling may be referenced by reviewing messages 412 and 414 as previously described in connection with FIG. 4. In addition, one or more IMS calls may have already been established by one or more of the first IMS client 508a or the second IMS client 508b as previously described in connection with messages 414, 416, 418, 420, 422 and 424 shown in FIG. 4, but are not shown in FIG. 5 in the interest of brevity.

The third IMS client 508c may transmit a start network interface message 510 indicating a request to establish a connection from the third IMS client 508c to the network 504 via a WiFi connection to the modem 506 and an LTE connection from the modem 506 to the network 504. The modem 506 may transmit a start network interface response message 512, which may indicate an IP address (e.g., 192.168.1.4) that will be associated with the WiFi connection between the third IMS client 508c and the modem 506. In response, the third IMS client 508c may transmit an SIP invite message 514 to the modem 506. As in FIG. 4, in order to ensure QoS for all devices on the network 504, there may be one or more policies in place limiting the number of concurrent connections between the IMS clients 508a-508c and the network 504 via a SoftAP (e.g., as the modem 506). Such limits may apply not only to calls, such as VoLTE but also for video telephony, rich communication service (RCS), etc. However, in contrast to the modem 406 of FIG. 4, the modem 506 of FIG. 5 may support IMS call prioritizing. Accordingly, granting of IMS call access is not limited to a first-come-first-serve basis and may instead be based on a priority associated with each requesting IMS client. Such priority may be determined based on at least one parameter associated with the requesting IMS client, as will be described in more detail below.

For example, after receiving the SIP invite message 514, the modem 506 may make a determination 516 as to whether the number of active calls is less than the number of allowed calls. If the answer is yes, the modem 506 may perform an IMS call bring up 518 for establishing the connection for the third IMS client 508c. When the IMS call has been established, the modem 506 may forward an HTTP response 520 including a 200 code indicating that the request for IMS call bring up for the third IMS client 508c was successful with the network 504. From this point forward, the SIP call between the third IMS client 508c and the network 504, via the modem 506 may be in progress.

However, if the answer to determination 516 is no, the modem 506 may make another determination 522 of the priority of the third IMS client 508c. Such priority may be determined based on at least one parameter associated with the requesting IMS client, as will be described in more detail below. If the priority of the third IMS client 508c is higher than at least one other IMS client already having a currently active IMS call, the modem 506 may preempt the lowest priority active call and connect the IMS call for the third IMS client 508c, as shown in block 524. This may be shown in further detail by block 526, where the modem 506 may perform IMS call bring up and IMS call clean up, which may include any necessary steps to terminate the lowest priority active call currently occurring through the modem 506 and to establish the IMS call for the third IMS client 508c. For example, in FIG. 5 the lowest priority call may be associated with the second IMS client 508b and the modem 506 may transmit a BYE or CANCEL message 528 to the second IMS client 508b indicating that the call was completed/terminated successfully. The modem 506 may then forward an HTTP response 530 having a 200 code indicating that the request for IMS call bring up for third IMS client 508c was successful with the network 504. From this point forward, the SIP call between the third IMS client 508c and the network 504, via the modem 506 may be in progress.

However, if the answer to determination 522 indicates that the priority associated with the third IMS client 508c has a lower priority than each of the IMS clients having a currently active IMS call, the modem 506 may transmit an error message 532 indicating an error code (e.g., 5XX/6XX error codes) for indicating that the service is unavailable or for indicating that the network is busy and the third IMS client 508c may not be granted access to the network 504 via the modem 506.

The present application contemplates several different methods by which a priority associated with a particular IMS client may be determined. In some implementations, a priority may be based on a priority field located in the SIP header of an SIP message sent from the requesting IMS client. Exemplary values for the priority field may include “non-urgent,” “normal,” “urgent,” and “emergency.” Of course, other additional values may be added on a per-implementation basis.

| IP ADDRESS, PORT NO. | PRIORITY | SERVICE |
|---|---|---|
| 192.168.1.1, 1000 | “NON-URGENT” | VoLTE |
| 192.168.1.2, 2000 | “NORMAL” | Video Telephony |
| 192.168.1.3, 3000 | “URGENT” | Video Telephony |
| 192.168.1.4, 4000 | “EMERGENCY” | VoLTE |

In operation, a network address translation table (NAT), as shown above, may include an added priority field. The priority entry for a particular IMS client may be stored based on the value indicated in a priority field in the SIP header. For example, a first IMS call may have a priority of “non-urgent,” may have been assigned an IP address and port number combination of 192.168.1.1, 1000 respectively, and may be for VoLTE service, for example. A second IMS call may have a priority of “normal,” may have been assigned an IP address and port number combination of 192.168.1.2, 2000 respectively, and may be for Video Telephony service, for example. A third IMS call may have a priority of “urgent,” may have been assigned an IP address and port number combination of 192.168.1.3, 3000 respectively, and may also be for Video Telephony service, for example. Finally, a fourth IMS call may have a priority of “emergency,” may have been assigned an IP address and port number combination of 192.168.1.4, 4000 respectively, and may be for VoLTE service, for example. Thus, in this case, if the number of allowed IMS connections via a particular 4G LTE modem is four, when a fifth IMS connection is requested by a fifth IMS client the modem may determine whether to allow the connection based on the priority field in the SIP header of a message of the fifth device as compared to the stored priority values of each of the first through fourth devices in the NAT. In this case, if the priority indicated in the SIP header for the fifth device is higher than “non-urgent” the modem may terminate the call associated with IP address, port no. combination 192.1638.1.1, 1000 as the lowest priority connection, and allow the connection request by the fifth device. In one implementation, the IP address, port no. combination 192.168.1.1, 1000 may be reassigned to the fifth device, the priority in the NAT may be stored as the priority indicated in the SIP header priority field from the fifth device, and the service type in the NAT may be stored according to the service type requested by the fifth device.

In some other implementations, priority of a particular IMS client may be based on the mobile directory number (MDN) of the requesting IMS client. In such a case, particular MDNs or blocks of MDNs may be assigned a particular priority value. These values may be assigned by the SoftAP, for example by the modem 506 of FIG. 5, automatically or manually via user input, or in the alternative, may be assigned by the LTE network, for example by the network 504.

| MDN NO. | IP/PORT NO. | PRIORITY | SERVICE |
|---|---|---|---|
| 8790023561 | 192.168.1.1, 1000 | 4 | VoLTE |
| 8790023562 | 192.168.1.2, 2000 | 3 | Video Telephony |
| 8790023563 | 192.168.1.3, 3000 | 2 | Video Telephony |
| 8254350264 | 192.168.1.4, 4000 | 1 | VoLTE |

For example, as shown in the NAT above, an MDN field and a priority field may be included along with the IP address and port number as well as service type for each connected device. In such an example, the priority of the particular IMS client may be based on the MDN of the IMS client. When an IMS client requests an IMS connection via the modem, the modem may make the determination as to whether or not to allow the IMS connection based on the MDN of the requesting IMS client. If the MDN of the requesting client is associated with a higher priority than at least one of the other IMS clients currently connected via the modem, the modem may terminate the connection for the IMS client having the lowest priority indicated in the NAT and the requesting IMS client connection request may be accepted. The required information for the newly connected IMS client may be stored in the NAT and, if necessary, the relative priority for each of the IMS clients currently stored in the NAT may be reordered to reflect the addition of the new IMS client.

Of course, the above example contemplates that each IMS client has a different MDN. However, where one or more of the IMS clients share the same MDN, the priority determination may be extended to include a configurable extension number or username associated with each IMS client. In such an instance, the modem or MiFi device may establish the IMS voice calls using its own MDN and may provide services to one or more IMS clients associated with the modem or MiFi device. Similarly, prioritization may further or alternatively be based on the remote party number the IMS client(s) is(are) attempting to contact. In such implementations, each remote party number or certain groups or blocks of remote party numbers may be assigned particular priorities that may be utilized by the modem to determine whether to allow or reject new IMS connections once the maximum allowed number of IMS calls or connections are in progress.

In yet other implementations, priority of a particular IMS client may be based on a combination of IP address and port number of the IMS client. For example, a NAT, as that shown below, may have a priority field added for each IP address-port number combination. The IMS service type may be stored for each IP address-port number combination. Thus, the priority of a particular IMS device may be based on a combination of IP address and port number assigned to or associated with the IMS device. In this way, if the maximum number of allowed calls or connections is reached, higher priority clients may be prioritized by bringing down the lowest priority call/connection of existing calls/connections.

| IP ADDRESS | PORT NO. | PRIORITY | SERVICE TYPE |
|---|---|---|---|
| 192.168.1.1 | 1000 | 1 | Voice Over LTE |
| 192.168.1.2 | 2000 | 2 | Video Telephony |

In yet other implementations, priority of a particular IMS client may be based on the assigned access class of the IMS client at the WiFi MAC layer during the random access channel (RACH). Exemplary values for the access class may include “voice,” “video,” “best effort,” and “background.” For example, because connections in the access class “voice” may be extremely sensitive to latency in the data delivery, “voice” access class connections may have a higher priority than the other classes. Similarly, “video” may have a higher priority than “best effort” and “background,” while “best effort” may have a higher priority than “background.” Of course, these priorities are only exemplary and may be arranged in any order desired on a per-implementation basis. Accordingly, when the limit for number of concurrent allowed connections has been reached the modem may make a determination as to whether to allow a new connection and which of the current connections to terminate based at least in part on the indicated access class of the current and new connections via the modem.

In yet other implementations, priority of a particular IMS client may be based on one or more enhanced multimedia priority service (MPS) codes or identifiers in the SIP invite message sent by the requesting IMS client. Of course, the present application is not limited to any single one of the above methods for establishing or determining priority and may include implementations where two or more of the above-mentioned methods are utilized in succession or in parallel, utilizing a multilevel prioritization, to arrive at an ultimate, definitive determination of the priority of the requesting IMS client and one or more currently connected IMS clients. Furthermore, where two or more IMS clients having the same priority are requesting the same service at the same time, priority may be decided based on further classification of services, for example video, voice or, when utilizing the rich communication suite (RCS), based on whether the specific service requested is for one to one chat, group instant messaging (IM), file transfer, or content sharing. Furthermore, it should be understood that the above methods may be carried out within or by the modem or MiFi device providing 4G LTE service to the non-4G-LTE-capabable IMS clients and not within the 4G LTE network itself. Accordingly, priorities are determined before the requesting IMS client is allowed access to the 4G LTE network via the modem.

The characteristic or characteristics utilized for determining priority by the modem 106/206 may be configured either automatically or via user input at the modem 106/206 in any of several exemplary ways. For example, in a first implementation, an IMS client, for example, any of the IMS clients 108a-108d or 208a-208d may include one or more of the above-mentioned priority parameters in one or more communications for a WiFi protected setup (WPS). In such an implementation, each IMS client may be configured to pass associated priority parameters to the SoftAP 106/206 when an initial WiFi connection is established.

In some other implementations, a command line interface and/or graphical user interface (GUI) may be provided at the SoftAP 106/206 via at least the user interface 322 and may allow for manual setup or configuration of the priority parameters to be utilized for determining IMS client priority as well as allow for adding static ports. In other implementations, the command line interface or GUI may be provided by one or more of the IMS clients 108a-108d or 208a-208d and the user input may be passed to the SoftAP 106/206 for priority parameter configuration.

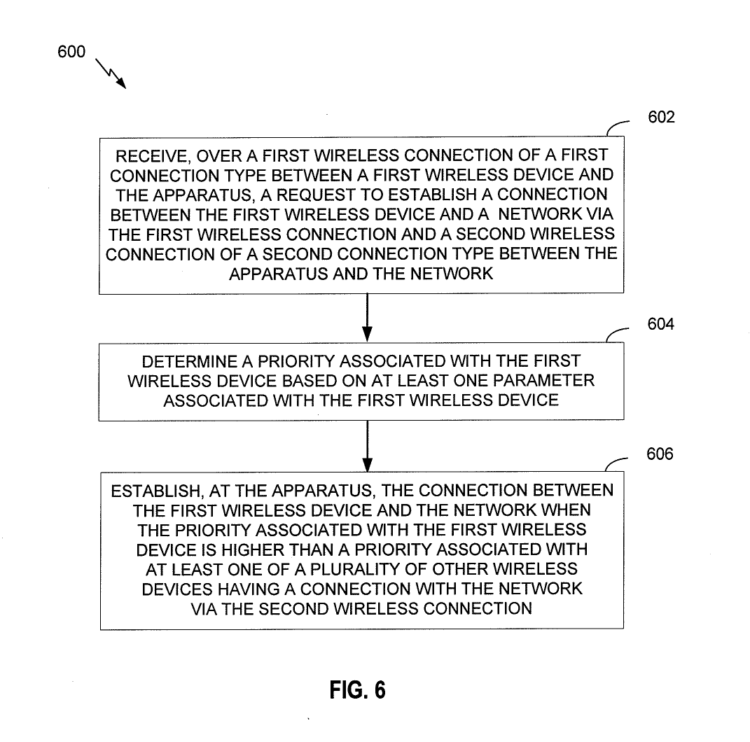

FIG. 6 illustrates a flowchart of an exemplary method for wireless communication by a wireless relay device that may be employed within the wireless communication network of FIG. 1 and/or FIG. 2. The method of flowchart 600 is described herein with reference to the signal exchange diagram 500 as previously described in connection with FIG. 5 and/or the wireless device 302 described in connection with FIG. 3. In one implementation, one or more of the steps in flowchart 600 may be performed by, or in connection with, a processor, transmitter and receiver, such as the processor 304, the transmitter 310 and/or the receiver 312 of FIG. 3, although those having ordinary skill in the art will appreciate that other components may be used to implement one or more of the steps described herein. Although blocks may be described as occurring in a certain order, the blocks can be reordered, blocks can be omitted, and/or additional blocks can be added.

The method may begin with block 602, which includes receiving, over a first wireless connection of a first connection type between a first wireless device and the apparatus, a request to establish a connection between the first wireless device and a network via the first wireless connection and a second wireless connection of a second connection type between the apparatus and the network. With respect to the signal exchange diagram 500 of FIG. 5, the first wireless connection type may be a WiFi connection and the second wireless connection type may be a 4G LTE connection, corresponding to one of the IMS call bring up 518 or the IMS call bring up 526. The first wireless device may correspond to the third IMS client 508c, the apparatus may correspond to the modem 506 and the network may correspond to the network 504. The request to establish the connection may correspond to the message 510 and/or the message 514.

The method may continue with block 604, which includes determining a priority associated with the first wireless device based on at least one parameter associated with the first wireless device. For example, with respect to the signal exchange diagram 500 of FIG. 5, the determining may correspond to determination 522 and may be performed by the modem 506. The at least one parameter may correspond to one or more of the above-mentioned parameters that may be utilized to determine IMS client priority. For example, a priority field located in the SIP header of an SIP message sent from the requesting IMS client, the MDN, extension or username of the IMS client, a remote party number the IMS client is attempting to reach, a combination of an IP address and port number associated with the IMS client, an assigned access class of the IMS client at the WiFi MAC layer, one or more enhanced MPS codes or identifiers in the SIP invite message sent by the requesting IMS client, a subscription or a type of IMS service requested by the IMS client.

The method may continue with block 606, which includes establishing, at the apparatus, the connection between the first wireless device and the network when the priority associated with the first wireless device is higher than a priority associated with at least one of a plurality of other wireless devices having a connection with the network via the second wireless connection. With respect to the signal exchange diagram 500 of FIG. 5, the plurality of other wireless devices may correspond to the first IMS client 508a and the second IMS client 508b. The establishing may correspond to the IMS call bring up 526.

In some implementations, the method may further include terminating a connection between a wireless device having a lowest priority of the at least one of the plurality of other wireless devices and the network. For example, with respect to the signal exchange diagram 500 of FIG. 5, the terminating may correspond to the block 524, where the modem 506 may preempt the lowest priority call and connect the new call.

In other implementations, the method may further include rejecting the request to establish the connection between the first wireless device and the network when the priority associated with the first wireless device is lower than the priority associated with each of the plurality of other wireless devices. For example, with respect to the signal exchange diagram 500 of FIG. 5, this step may correspond to a lowest priority determination at determination 522 and subsequently transmitted error message 532, which may comprise an error code indicating “service unavailable” or “network busy.”

In yet other implementations, the method may further include configuring how the modem determines the priority in one or more of the following ways. A first option may comprise receiving the at least one parameter from the first wireless device via a WiFi protected setup (WPS) sequence. Such a WPS sequence may occur during initial WiFi connection setup between the first wireless device and the wireless relay device or modem. A second option may comprise providing a command line interface at the wireless relay device for adding static ports and/or for configuring the determining by a user. Such an option may be provided by at least the user interface 322 of wireless device 302 as shown in FIG. 3. A third option may comprise providing a graphical user interface at the wireless relay device for configuring the determining by the user. As with the second option, the third option may be provided by at least the user interface 322 of the wireless device 302.

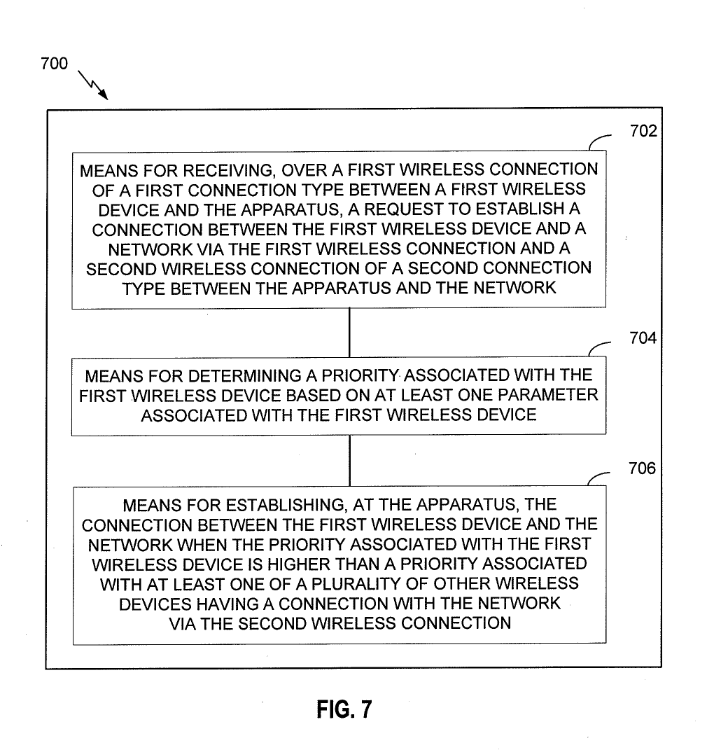

FIG. 7 illustrates an example of a functional block diagram of an apparatus 700 for wireless communication that may be employed within the wireless communication network of FIG. 1. Those skilled in the art will appreciate that a networked communication apparatus may have more components than the simplified networked communication apparatus 700 shown in FIG. 7. The apparatus 700 shown includes only those components useful for describing some prominent features of implementations within the scope of the claims.

The apparatus 700 includes means 702 for receiving, over a first wireless connection of a first connection type between a first wireless device and the apparatus, a request to establish a connection between the first wireless device and a network via the first wireless connection and a second wireless connection of a second connection type between the apparatus and the network. In an implementation, the means 702 can be configured to perform one or more of the functions described above with respect to block 602 (FIG. 6). In various implementations, the means 702 can be implemented by the modem 506 of FIG. 5, and more specifically by the receiver 312 and/or the processor 304 of the wireless device 302 shown in FIG. 3.

The apparatus 700 may further comprise means 704 for determining a priority associated with the first wireless device based on at least one parameter associated with the first wireless device. In an implementation, the means 704 can be configured to perform one or more of the functions described above with respect to block 604 (FIG. 6). In various implementations, the means 704 can be implemented by the modem 506 of FIG. 5, and more specifically by the processor 304 of the wireless device 302 shown in FIG. 3.

The apparatus 700 may further comprise means 706 for establishing, at the apparatus, the connection between the first wireless device and the network when the priority associated with the first wireless device is higher than a priority associated with at least one of a plurality of other wireless devices having a connection with the network via the second wireless connection. In an implementation, the means 706 can be configured to perform one or more of the functions described above with respect to block 606 (FIG. 6). In various implementations, the means 706 can be implemented by the modem 506 of FIG. 5, and more specifically by the processor 304 of the wireless device 302 shown in FIG. 3. The means 706 may also utilize the transmitter 310 and the receiver 312.

In some implementations, the apparatus 700 may additionally include means for terminating a connection between a wireless device having a lowest priority of the at least one of the plurality of other wireless devices and the network (not shown). In various implementations, the means for terminating can be implemented by the modem 506 of FIG. 5, and more specifically by the processor 304 of the wireless device 302 shown in FIG. 3.

In other implementations, the apparatus 700 may additionally include means for rejecting the request to establish the connection between the first wireless device and the network when the priority associated with the first wireless device is lower than the priority associated with each of the plurality of other wireless devices (not shown). In various implementations, the means for rejecting can be implemented by the modem 506 of FIG. 5, and more specifically by the processor 304 of the wireless device 302 shown in FIG. 3.

In yet other implementations, the apparatus 700 may additionally include means for configuring the means 704 for determining (not shown). Such means for configuring may provide at least one of the three options described above for configuring how the apparatus 700 may determine priority. In various implementations, the means for configuring can be implemented by the modem 506 of FIG. 5, and more specifically by the user interface 322 and/or the processor 304 of the wireless device 302 shown in FIG. 3.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communication by a wireless relay device, comprising:
receiving, over a first wireless connection of a first connection type between a first wireless device and the relay device, a request to establish a connection between the first wireless device and a network via the first wireless connection and a second wireless connection of a second connection type between the relay device and the network;
determining a priority associated with the first wireless device based on at least one parameter associated with the first wireless device; and
establishing, at the relay device, the connection between the first wireless device and the network when the priority associated with the first wireless device is higher than a priority associated with at least one of a plurality of other wireless devices having a connection with the network via the second wireless connection.

2. The method of claim 1, wherein the at least one parameter comprises one or more of the following: an IP multimedia subsystem service type, an MPS identifier in a session initiation protocol invite message, a priority field in a session initiation protocol header, a mobile directory number, an extension associated with the mobile directory number, a combination of an IP address and port number, an access class, a remote party number, a subscription level and a call type.

3. The method of claim 1, further comprising terminating a connection between a wireless device having a lowest priority of the at least one of the plurality of other wireless devices and the network.

4. The method of claim 1, further comprising rejecting the request to establish the connection between the first wireless device and the network when the priority associated with the first wireless device is lower than the priority associated with each of the plurality of other wireless devices.

5. The method of claim 1, further comprising configuring the determining the priority by one of the following:
receiving the at least one parameter from the first wireless device via a WiFi protected setup sequence;
providing a command line interface at the wireless relay device for adding static ports or for configuring the determining by a user; and
providing a graphical user interface at the wireless relay device for configuring the determining by the user.

6. The method of claim 1, wherein the first connection type is a WiFi connection.

7. The method of claim 1, wherein the second connection type is a fourth generation long term evolution connection.

8. An apparatus for wireless communication, comprising:
a receiver configured to receive, over a first wireless connection of a first connection type between a first wireless device and the apparatus, a request to establish a connection between the first wireless device and a network via the first wireless connection and a second wireless connection of a second connection type between the apparatus and the network;
a processor configured to:
determine a priority associated with the first wireless device based on at least one parameter associated with the first wireless device; and
establish, at the apparatus, the connection between the first wireless device and the network when the priority associated with the first wireless device is higher than a priority associated with at least one of a plurality of other wireless devices having a connection with the network via the second wireless connection.

9. The apparatus of claim 8, wherein the at least one parameter comprises one or more of the following: an IP multimedia subsystem service type, an MPS identifier in a session initiation protocol invite message, a priority field in a session initiation protocol header, a mobile directory number, an extension associated with the mobile directory number, a combination of an IP address and port number, an access class, a remote party number, a subscription level and a call type.

10. The apparatus of claim 8, wherein the processor is further configured to terminate a connection between a wireless device having a lowest priority of the at least one of the plurality of other wireless devices and the network.

11. The apparatus of claim 8, wherein the processor is further configured to reject the request to establish the connection between the first wireless device and the network when the priority associated with the first wireless device is lower than the priority associated with each of the plurality of other wireless devices.

12. The apparatus of claim 8, wherein the processor is further configured to configure the determining the priority by one of the following:
receiving the at least one parameter from the first wireless device via a WiFi protected setup;
providing a command line interface at the apparatus for adding static ports or for configuring the determining by a user; and
providing a graphical user interface at the apparatus for configuring the determining by the user.

13. The apparatus of claim 8, wherein the first connection type is a WiFi connection.

14. The apparatus of claim 8, wherein the second connection type is a fourth generation long term evolution connection.

15. A non-transitory computer-readable medium comprising code that, when executed, causes an apparatus to:
receive, over a first wireless connection of a first connection type between a first wireless device and the apparatus, a request to establish a connection between the first wireless device and a network via the first wireless connection and a second wireless connection of a second connection type between the apparatus and the network;
determine a priority associated with the first wireless device based on at least one parameter associated with the first wireless device; and
establish, at the apparatus, the connection between the first wireless device and the network when the priority associated with the first wireless device is higher than a priority associated with at least one of a plurality of other wireless devices having a connection with the network via the second wireless connection.

16. The non-transitory computer-readable medium of claim 15, wherein the at least one parameter comprises one or more of the following: an IP multimedia subsystem service type, an MPS identifier in a session initiation protocol invite message, a priority field in a session initiation protocol header, a mobile directory number, an extension associated with the mobile directory number, a combination of an IP address and port number, an access class, a remote party number, a subscription level and a call type.

17. The non-transitory computer-readable medium of claim 15, wherein the code, when executed, causes the apparatus to terminate a connection between a wireless device having a lowest priority of the at least one of the plurality of other wireless devices and the network.

18. The non-transitory computer-readable medium of claim 15, wherein the code, when executed, causes the apparatus to reject the request to establish the connection between the first wireless device and the network when the priority associated with the first wireless device is lower than the priority associated with each of the plurality of other wireless devices.

19. The non-transitory computer-readable medium of claim 15, wherein the code, when executed, causes the apparatus to configure the determining the priority by one of the following:
receiving the at least one parameter from the first wireless device via a WiFi protected setup;
providing a command line interface at the apparatus for adding static ports or for configuring the determining by a user; and
providing a graphical user interface at the apparatus for configuring the determining by the user.

20. The non-transitory computer-readable medium of claim 15, wherein the first connection type is a WiFi connection.

21. The non-transitory computer-readable medium of claim 15, wherein the second connection type is a fourth generation long term evolution connection.

22. An apparatus for wireless communication, comprising:
means for receiving, over a first wireless connection of a first connection type between a first wireless device and the apparatus, a request to establish a connection between the first wireless device and a network via the first wireless connection and a second wireless connection of a second connection type between the apparatus and the network;
means for determining a priority associated with the first wireless device based on at least one parameter associated with the first wireless device; and
means for establishing, at the apparatus, the connection between the first wireless device and the network when the priority associated with the first wireless device is higher than a priority associated with at least one of a plurality of other wireless devices having a connection with the network via the second wireless connection.

23. The apparatus of claim 1, wherein the at least one parameter comprises one or more of the following: an IP multimedia subsystem service type, an MPS identifier in a session initiation protocol invite message, a priority field in a session initiation protocol header, a mobile directory number, an extension associated with the mobile directory number, a combination of an IP address and port number, an access class, a remote party number, a subscription level and a call type.

24. The apparatus of claim 1, further comprising means for terminating a connection between a wireless device having a lowest priority of the at least one of the plurality of other wireless devices and the network.

25. The apparatus of claim 1, further comprising means for rejecting the request to establish the connection between the first wireless device and the network when the priority associated with the first wireless device is lower than the priority associated with each of the plurality of other wireless devices.

26. The apparatus of claim 1, further comprising means for configuring the means for determining the priority by one of the following:
receiving the at least one parameter from the first wireless device via a WiFi protected setup;
providing a command line interface at the apparatus for adding static ports or for configuring the determining by a user; and
providing a graphical user interface at the apparatus for configuring the determining by the user.

27. The apparatus of claim 1, wherein the first connection type is a WiFi connection.

28. The apparatus of claim 1, wherein the second connection type is a fourth generation long term evolution connection.
